(19) United States
(12) Patent Application Publication
(10) Pub. No.: US 2017/0179807 A1
(43) Pub. Date: Jun. 22, 2017

(54) MAGNETIC MOTOR DEVICE OF AN ELECTRODYNAMIC TRANSDUCER

(71) Applicant: RENAULT s.a.s., Boulogne-Billancourt (FR)

(72) Inventors: Claire Peteul-Brouillet, Viroflay (FR); Mathias Remy, Limours (FR); Guy Lemarquand, Le Mans (FR); Gael Guyader, Chaudon (FR)

(73) Assignee: RENAULT s.a.s., Boulogne-Billancourt (FR)

(21) Appl. No.: 15/394,166

(22) Filed: Dec. 29, 2016

Related U.S. Application Data
(63) Continuation of application No. 14/217,766, filed on Mar. 18, 2014, now abandoned.
Application No. 14/217,766 is a continuation of application No. 13/984,457, now abandoned.

(30) Foreign Application Priority Data
Feb. 8, 2011 (FR) 11 50993

(51) Int. Cl. H02K 41/035; H02K 1/12; H04R 9/02; H02K 41/03

(52) U.S. Cl. CPC H02K 41/0356; H02K 41/031; H02K 1/12; H04R 9/025

(57) ABSTRACT

A magnetic motor device of an electrodynamic transducer, which includes a bonded annular magnet and a tubular element mounted coaxially relative to the bonded annular magnet. The bonded annular magnet includes a magnetic cylindrical surface, while the tubular element includes a winding extending opposite the magnetic cylindrical surface, the tubular element configured to be driven axially relative to the bonded angular magnet when electric power is supplied to the winding. A metal tubular member includes a metal cylindrical surface, and the metal tubular member is mounted coaxially relative to the tubular element such that the metal cylindrical surface extends opposite the magnetic cylindrical surface relative to the winding.

### CROSS-REFERENCE TO RELATED APPLICATIONS

This application is a continuation of U.S. application Ser. No. 14/217,766, filed Oct. 17, 2014, which is continuation of U.S. application Ser. No. 13/984,457, which is a U.S. National Stage of PCT/FR12/050262, filed Feb. 7, 2012, the entire contents of each of which is incorporated herein by reference, and claims the benefit of priority under 35 U.S.C. §119 from French Application No. 11 50993, filed Feb. 8, 2011.

The present invention relates to a magnetic motor device of an electrodynamic transducer, comprising a bonded annular magnet and a tubular element which carries a coil and is mounted so as to be movable in translation coaxially relative to the bonded annular magnet.

A device of this type is intended in particular, but not exclusively, to be used in the construction of electrodynamic loudspeakers.

Known magnetic motor devices comprise fixed elements: a permanent annular magnet, two metal rings containing iron and coaxially sandwiching the permanent magnet so as to form field plates, and a core, also containing iron, mounted coaxially with the center of the permanent magnet, and also comprise moving elements: a coiled cylindrical support held coaxially in the gap between the magnet and the core, and a membrane connected to the coiled cylindrical support. The coiled cylindrical support is made of card for example and comprises wire windings, for example made of copper, and the supply of electrical current to these wires causes the axial movement of the coiled support in the gap and consequently the movements of the membrane. It is these movements of the membrane which then cause the vibration of the air and generate the sound.

Also, numerous elements of these devices intended to guide the field lines of the magnet contain iron, which causes a certain number of non-linearities, which are detrimental to the quality and faithfulness of the sound output of the transducer.

Consequently, all-magnet devices, not containing iron, have been conceived. However, the traditional sintered magnets are relatively complex to form and to adapt to specific geometries.

Also, bonded magnets, plastic magnets or elastic magnets, which can be shaped as desired, have also been conceived. In fact, these are produced by injection molding in a mold, which may have a very large variety of forms. This makes it possible to create elements of which the useful magnetic field is improved and consequently to limit the leakage field, which is a primary fault of conventional sintered magnets.

Document EP 2 114 086 therefore relates to a magnetic motor device devoid of field plates, but of which the permanent magnet is a bonded annular magnet, of specific shape having a cylindrical surface and, opposite, a convex surface. This document in particular discloses a magnetic device of which the bonded magnet is arranged inside the coiled support, the bonded magnet having an outer cylindrical surface which extends opposite wire windings and a convex surface which extends toward the inside of the magnet. This convex surface is such that the path of an axial plane of the bonded magnet and of the convex surface is a hemi-ellipse. Furthermore, the outer cylindrical surface has two cylindrical parts that are mutually opposed relative to the mid-plane of the magnet.

According to an axial plane, the field lines thus extend from one part to the other inside the magnet parallel to the curve defined by the hemi-elliptical convex surface, cutting the cylindrical surface substantially perpendicularly. This makes it possible to effectively concentrate the magnetic field toward the wire windings of the coiled support.

However, the field lines do not close up easily beyond the coiled support opposite the magnet. Also, document EP 2 114 086 discloses the use of a bonded magnet around the coiled support and symmetrical with the magnet which is housed inside so as to close up the field lines in order to obtain better linearity of the magnetic field and to limit magnetic leakages.

However, the use of an additional magnet around the coiled support increases the weight and bulk of the magnetic motor device. Furthermore, bonded magnets, plastic magnets or elastic magnets are poor conductors of thermal energy, and consequently the thermal energy generated in the coil, where the temperature may reach 170° C., is only dissipated with great difficulty.

Also, a problem that arises and that the present invention aims to solve is that of providing a magnetic motor device which makes it possible not only to limit the magnetic leakage field, but also the accumulation of thermal energy.

With this objective, the present invention relates to a magnetic motor device of an electrodynamic transducer, comprising a bonded annular magnet generating a magnetic field and also a tubular element mounted coaxially relative to said bonded annular magnet, said bonded annular magnet having a magnetic cylindrical surface, While said tubular element comprises a coil extending opposite said magnetic cylindrical surface, said tubular element being designed to be driven axially relative to said bonded annular magnet when electrical current is supplied to said coil. According to the invention, the device also comprises a metal tubular member having a metal cylindrical surface, and said metal tubular member is mounted coaxially relative to said tubular element in such a way that said metal cylindrical surface extends opposite said magnetic cylindrical surface relative to said coil so as to close said magnetic field.

A feature of the invention thus lies in the arrangement of the metal tubular member opposite the bonded annular magnet relative to the coiled tubular element so as to close the magnetic field. The leakage field is thus very strongly limited compared to conventional structures and the magnetic field is concentrated through the coiled tubular element.

Furthermore, the thermal energy generated in the coil dissipates easily through the metal tubular member, which by nature is a good thermal conductor. According to the prior art, in the absence of a metal tubular member, it is necessary to incorporate into the bonded annular magnet costly materials enabling this thermal dissipation.

Besides the thermal dissipation, the metal tubular member, for example formed from an iron alloy, makes it possible to improve the dimensional manufacturing tolerances.

In addition, said bonded annular magnet, which is quite clearly completely solid, advantageously has a surface opposite said magnetic cylindrical surface, of which the intersection with an axial plane of said bonded annular magnet is a hemi-ellipse. A hemi-ellipse is a curve defined by an ellipse cut along one of these two axes, whether along its small axis, which extends between its two centers, or along its large axis, which cuts precisely the two centers. The magnetic field lines thus extend, along an axial plane, from one cylindrical pail arranged on one side of the mid-plane of the bonded annular magnet to the other, through the magnet, closely following the curve defined by the opposed hemi-elliptical surface and cutting the cylindrical surface of the magnet substantially perpendicularly. The magnetic field lines thus pass through the coiled tubular element radially, then rejoin, likewise radially, the metal tubular member so as to then bend and extend through in an axial direction, as will be explained in greater detail in the description hereinafter.

In accordance with an embodiment basically aiming to reduce the weight and/or the bulk of the magnetic motor device, said opposite surface has a truncation forming a truncated cylindrical surface substantially parallel to said magnetic cylindrical surface.

Preferably, said magnetic cylindrical surface of said bonded annular magnet has two first cylindrical half-surfaces, while said bonded annular magnet generates a magnetic field B, and the ratio of the first cylindrical half-surface to the cross section of the metal tubular member, this being a factor of said magnetic field B, is less than the value of the magnetic saturation threshold of the material of said metal tubular member. The cross section of the tubular member corresponds to the surface of said cross section and consequently to the difference of the outer radius and inner radius surfaces of the tubular member. The required thickness of the metal tubular member is thus determined easily, and in particular use of a tubular member that is too bulky and heavy is avoided. For example, the ratio of the first cylindrical half-surface to the cross section of the metal tubular member, this being a factor of said magnetic field B, is thus less than 1.5 when said metal tubular member is made of iron.

In accordance with a particularly advantageous embodiment of the invention, said metal cylindrical surface has two second cylindrical half-surfaces arranged in the axial extension of one another and divided equally by a mid-plane of the tubular member, while said coil is divided into two windings interspaced axially and able to extend opposite said second cylindrical half-surfaces respectively. The two axially interspaced windings are formed by a single wire, but are wound in opposite directions. When the feed current is supplied to the wire, it thus circulates in two opposite directions between the two windings. The two windings are thus adjusted to the right of the two opposed parts of the bonded annular magnet respectively, such that the two beams of field lines passing through the two windings are oriented in opposite directions. The forces exerted on the coiled tubular element are also double, which increases the power of the motor device.

In addition, in accordance with a first variant, said bonded annular magnet is mounted inside said tubular element, while said metal tubular member extends around said tubular element. The thermal energy generated in the windings can thus dissipate through the metal tubular member and radially toward the outside of the motor device when the space around said motor device is free. In accordance with another variant, which makes it possible to evacuate the thermal energy axially toward the rear of the motor device, said metal tubular member is mounted inside said tubular element, while said bonded annular magnet extends around said tubular element.

Further features and advantages of the invention will become clear from reading the following description of a specific embodiment of the invention, provided by way of non-limiting example and with reference to the accompanying drawings, in which:

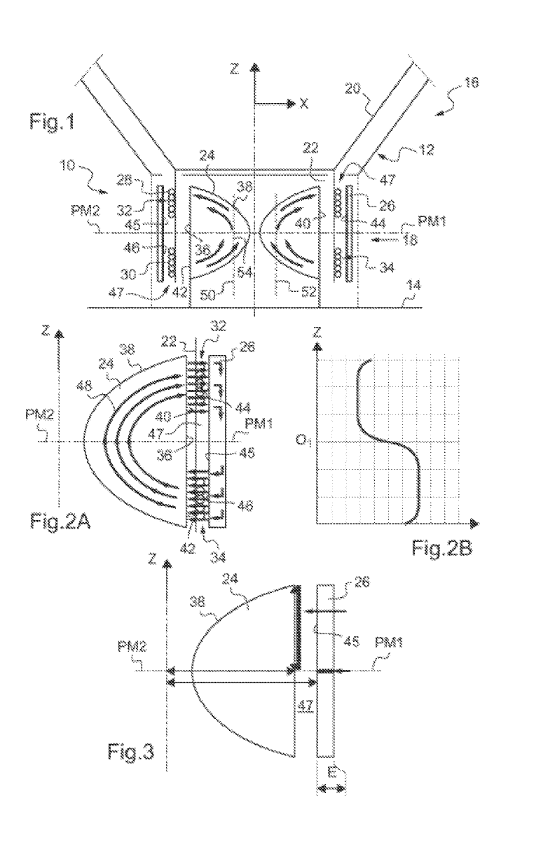

FIG. 1 is a schematic axial sectional view of a magnetic motor device according to the invention in accordance with one embodiment;

FIG. 2A is a partial schematic axial sectional view of a detail of FIG. 1;

FIG. 2B is a graph corresponding to FIG. 2A, illustrating the strength of the local magnetic field; and

FIG. 3 is a schematic view similar to FIG. 2A, illustrating the dimensional references.

FIG. 1 illustrates an embodiment of a magnetic motor device of an electrodynamic transducer 10. The magnetic motor device comprises a receiving part 12 connected to a base 14. The receiving part 12 comprises a frustoconical part 16 integral with a tubular part of circular base 18. The frustoconical part 16 carries a membrane 20, while the tubular part 18 includes, coaxially with the axis of the device Z, a tubular element 22 forming a support and integral with the membrane 20, a bonded annular magnet 24 arranged inside the tubular element 22, and a metal tubular member 26 surrounding the tubular element 22. The tubular element 22 is made of card, aluminum, polyimide or glass fibers, or a composite material. Furthermore, the tubular element 22 has a first cylindrical tubular element border 28 close to the attachment to the membrane 20 and a second cylindrical tubular element border 30 spaced from the attachment to the membrane 20. In addition, the tubular element comprises a first winding 32 of a conductor wire made of copper, aluminum or any other alloy of these materials, and even made of silver in some cases, arranged close to the first cylindrical tubular element border 28, and a second winding 34 of said conductor wire in the opposite direction arranged close to the second cylindrical tubular element border 30. The two windings 32, 34 are quite clearly connected by the same conductor wire.

The bonded annular magnet 24 extends in the tubular part 18 and inside the tubular element 22. The bonded annular magnet has an outer magnetic cylindrical surface 36 which extends opposite and at a distance from the tubular element 22 and opposite (inwardly) an opposed surface 38 having, in the plane of the drawing corresponding to an axial plane of the bonded annular magnet 24, a half-ellipse shape. The bonded annular magnet 24 has a first mid-plane P_{M1} perpendicular to the axis Z of the device. The bonded annular magnet 24, in its outer magnetic cylindrical surface 36, also has in its upper part, above the mid plane P_{M1}, an upper outer cylindrical half-surface 40 extending opposite the first winding 32 of conductor wire, and in its lower part, below the mid-plane P_{M1}, a lower outer cylindrical half-surface 42 extending opposite the second winding 34 of conductor wire.

The bonded annular magnet 2.4 is quite clearly fixed in position relative to the tubular part 18, for example via the base 14.

The metal tubular member 26, for example formed on the basis of iron, is also fixed in position inside the tubular part 18 and extends coaxially around and at a distance from the tubular element 22. The metal tubular member has a second mid-plane P_{M2}, coinciding in FIG. 1 with the first mid-plane P_{M1} of the bonded annular magnet 24. As will be explained in greater detail hereinafter, the tubular element 22 is free relative to the bonded annular magnet 24 and the metal tubular member 26 and is axially movable relative thereto.

The metal tubular member 26 has an inner cylindrical surface 45 divided into two inner cylindrical half-surfaces mutually opposed relative to the second mid-plane P_{M2}: an upper inner cylindrical half-surface 44, which extends opposite the first winding 32 of conductor wire, and, opposite relative to the second mid-plane P_{M2}, a lower inner cylindrical half-surface 46, which extends opposite the second winding 34 of conductor wire.

The coiled tubular element 22 is thus assembled freely in an annular chamber 47, or gap, which extends between the metal tubular member 26 and the bonded annular magnet 24. It is movable axially about a rest position in order to entrain the membrane 20.

Reference is made to FIG. 3 in order to define the dimensions and relative positions of the bonded annular magnet 24 and of the metal tubular member 26. FIG. 3 is a detailed view illustrating a hemi-section of the bonded annular magnet 24 and of the metal tubular member 26.

The bonded annular magnet 24 thus has a radius R and a height H from the mid-plane P_{M1} corresponding to the height of the upper outer cylindrical half-surface 40, while the metal tubular member 26 has a thickness E and an inner radius R2. This thickness E is determined relative to the maximum field density before saturation of the material, and in this case of the iron. The ratio between the outer cylindrical half-surface of the bonded annular magnet 24, in the gap 47, to the cross section of the metal tubular member 26 along the mid-plane P_{M2}, this being a factor of the magnetic field imparted by the bonded annular magnet 24, must therefore be less than the value of the magnetic saturation threshold of the material used, for example 1.5 for iron.

Also, by selecting for the bonded annular magnet 24 a radius R of 10 mm and a height H of 6 mm, corresponding to a total half-height of the bonded annular magnet 24, for a magnetic field of 0.4 T (tesla) imparted by a neodymium charge of the bonded annular magnet, and by selecting for the metal tubular member 26 an inner radius R2 of 11 mm thus defining a gap 47 of 1 mm, and a thickness of the metal tubular member 26 E of 2 mm, a field density in the metal tubular member 26 close to 1.0 I is obtained. This value is less than 1.5 T.

Reference is now made to FIG. 2A, showing the magnetic field lines 48 which extend between the bonded annular magnet 24 and the metal tubular member 26, in order to describe the advantages of the magnetic motor device according to the invention. In FIG. 2A, the tubular element 22 is also shown in part, equipped with its two windings, that is to say the first winding 32 and the second winding 34.

The curved magnetic field lines 48 thus extend inside the bonded annular magnet 24, along an axial section, substantially parallel to the opposite surface 38 of the outer cylindrical magnetic surface 36 so as to lead perpendicularly into the two half-surfaces 40, 42 respectively. These magnetic field lines 48 are oriented here, in FIG. 2A, in a clockwise direction. Also, the magnetic field is oriented in the gap 47 from the upper outer half-surface 40 of the bonded annular magnet 24 toward the upper inner cylindrical half-surface 44 of the metal tubular member 26. It is then guided axially in the metal tubular member 26 toward the lower inner cylindrical half-surface 46 and passes in the opposite direction through the gap 47 toward the lower outer cylindrical half-surface 42 so as to rejoin the bonded annular magnet 24. FIG. 2B correspondingly shows the variations of the magnetic field in the gap 47, said magnetic field reversing in the lower part compared to the upper part, as has just been explained above.

The linearity of the magnetic field usable in the gap 47 is therefore no longer linked to the outer elements, but to the single metal tubular member 46. The sound quality of a loudspeaker produced with the magnetic motor device according to the invention is thus increased. Furthermore, and as has been explained above, the geometry of the metal tubular member 46 can be perfectly determined, and in particular its thickness, as a function of the maximum field density of the material used, that is to say 1.5 T in the case of iron.

Furthermore, the tubular element 22 having the two windings 32, 34 is entirely adjusted in the magnetic field, which makes it possible to achieve increased linearities and to improve yet further the output sound quality.

In accordance with the present embodiment, the metal tubular member 26 is arranged around the tubular element 22, while the bonded annular magnet 24 is arranged inside the tubular element. Insofar as the space around the metal tubular member 26 is relatively free, the thermal dissipation is thus large. The elements used made of plastic material, in particular in order to guide the tubular element 22, are thus protected from heat.

However, another embodiment in Which the metal tubular member 26 and the bonded annular magnet 24 are exchanged, in another, reverse arrangement, is envisaged. The metal tubular member 26 thus evacuates the thermal energy axially.

In accordance with vet a further embodiment, illustrated in FIG. 1 by dashed lines 50, 52 parallel to the axis of the device Z, the opposed surface 38 of the bonded annular magnet 24 has a truncation thus forming a truncated cylindrical surface 54 parallel to and coaxial with the magnetic cylindrical surface 36. The annular magnet 24 is thus made lighter.

1. A magnetic motor device of an electrodynamic transducer, comprising:
a bonded annular magnet generating a magnetic field; and
a tubular element mounted coaxially relative to the bonded annular magnet;
the bonded annular magnet including a magnetic cylindrical surface;
the tubular element including a coil extending opposite the magnetic cylindrical surface, the tubular element configured to be driven axially relative to the bonded annular magnet when electrical current is supplied to the coil;
and further comprising:
a metal tubular member including a metal cylindrical surface,
wherein the metal tubular member is mounted coaxially relative to the tubular element such that the metal cylindrical surface extends opposite the magnetic cylindrical surface relative to the coil so as to close the magnetic field.

2. The magnetic motor device as claimed in claim 1, wherein the bonded annular magnet includes a surface opposite the magnetic cylindrical surface, of which an intersection with an axial plane of the bonded annular magnet is a hemi-ellipse.

3. The magnetic motor device as claimed in claim 2, wherein the opposite surface has a truncation forming a truncated cylindrical surface substantially parallel to the magnetic cylindrical surface.

4. The magnetic motor device as claimed in claim 1, wherein the magnetic cylindrical surface of the bonded annular magnet includes two first cylindrical half-surfaces, while the bonded annular magnet generates a magnetic field B, and a ratio of the first cylindrical half-surface to cross section of the metal tubular member, which is a factor of the magnetic field B, is less than a value of magnetic saturation threshold of material of the metal tubular member. Claims. The magnetic motor device as claimed in claim 4, wherein the ratio of the first cylindrical half-surface to the cross section of the metal tubular member, which is a factor of the magnetic field B, is less than 1.5 when the metal tubular member is made of iron.

6. The magnetic motor device as claimed in claim 1, wherein the metal cylindrical surface includes two second cylindrical half-surfaces arranged in an axial extension of one another, and the coil is divided into two windings interspaced axially and configured to extend opposite the second cylindrical half-surfaces respectively.

7. The magnetic motor device as claimed in claim 1, wherein the bonded annular magnet is mounted inside the tubular element, and the metal tubular member extends around the tubular element.

8. The magnetic motor device as claimed in claim 3, wherein the metal tubular member is mounted inside the tubular element, and the bonded annular magnet extends around the tubular element.
